(19) United States
(12) Patent Application Publication
(10) Pub. No.: US 2010/0256319 A1
(43) Pub. Date: Oct. 7, 2010

(54) MELT SPINNING PROCESS FOR THE PRODUCTION OF SYNTHETIC POLYMER CONTINUOUS FILAMENT YARNS

(76) Inventors: Fabio Pereira De Lacerda, Cep: (BR); Pierre Hansu Pak, Sao Bernardo do Campo (BR); Thomas Gonzaga Canova, Santo Andre (BR)

Correspondence Address: BUCHANAN, INGERSOLL & ROONEY PC, POST OFFICE BOX 1404, ALEXANDRIA, VA, 22313-1404, US

(21) Appl. No.: 12/671,336

(22) PCT Filed: Aug. 8, 2008
(86) PCT No.: PCT/BR2008/000234

§ 371 Date: May 24, 2010

(30) Foreign Application Priority Data
Aug. 8, 2007 (FR) 07/05758

(51) Int. Cl. D01D 5/30; C08G 73/10; C08G 63/183; C08F 110/06

(52) U.S. Cl. 526/351; 264/172.11; 528/310; 528/308; 528/308.1

(57) ABSTRACT

A melt spinning process for the production of synthetic polymer continuous filament yarns useful in the continuous filament production industry, suitable such polymers including those that are melt-spun, e.g., inter alia, polyesters, polyamides and polyolefins, and wherein the spinning process includes two filtration steps: a first step corresponding to a prefiltration employing one or more centralized filters located at a point on the polymer melt transfer lines and a final filtration carried out in the filtering elements of the screen-pack/spinneret assemblies.

The field of application of the present invention is the industry of producing synthetic continuous filament yarns.

The spinning process for the production of textile or industrial yarns comprising continuous filaments consists in converting a synthetic polymer, such as for example nylon-6 polyamide, nylon-6,6 polyamide, polypropylene, PBT (polybutylene terephthalate) or PET (polyethylene terephthalate), in the form of granules (pellets or chips) or in the form of a melt, into the form of synthetic continuous filament yarns.

In the prior art, textile or industrial yarns comprising continuous filaments may be classified, according to their specifications and mechanical characteristics, in the following categories:
LOY (Low Oriented Yarn), which is characterized by an elongation at break of greater than 200% and which still requires a drawing operation, as a subsequent texturing process, or a drawing operation to obtain the mechanical properties needed for the direct use in the applications in which it is required;
POY (Partially Oriented Yarn), which is characterized by an elongation at break of between 50 and 200% and which still requires a drawing operation as a subsequent texturing process, or a drawing operation to obtain the mechanical properties needed for the direct use in the applications in which it is required;
FDY (Fully Drawn Yarn), which is characterized by an elongation at break of between 5% and 50% and already possesses the mechanical properties needed for the direct use in the applications in which it is required, i.e. as textile yarn or industrial yarn; and
chopped fibres, obtained from the yarns described above.

In addition, another characteristic of synthetic continuous filament yarns is the titre or linear density of the yarn, which is typically between 20 and 3000 dtex (grams/10000 m).

Furthermore, another characteristic of synthetic continuous filament yarns is the number of filaments per yarn, which is typically between 5 and 500 filaments.

The combination of the linear density of the yarn and the number of filaments defines another characteristic of the yarn, which is the linear density per filament, usually denoted dpf (dtex per filament), which typically lies between 0.5 and 10 dpf. Yarns having a dpf of less than 1.5 are commonly called microfibres and are products providing particular properties in textile applications, especially in terms of feel and comfort that they give garments.

In addition, another characteristic of synthetic continuous filament yarns is the presence of additives at various concentrations in the formulations used to manufacture them, so as to give them specific properties or functions, such as for example an opacifying function, an ultraviolet radiation protection function, a thermal degradation protection function, a bactericidal function, an acaricidal function, a fungicidal function or a bulk-tinting function.

The raw material, or polymer, fed into a spinning process is produced in a polymerization process carried out in a polymerization installation.

The polymer thus obtained in a polymerization installation is delivered into the spinning devices or installations.

The polymer may be fed in granule form or in melt form, or in a combination of the two.

In the case of a feed in granule form, the polymer is granulated at the exit from the polymerization installation. The delivery into the various spinning devices is obtained by means of trays or containers, in the case in which the polymerization and spinning installations are not located on the same production site, or by a pneumatic transport system if they are located on the same site.

In the case of a feed in melt form, the polymer is fed into the spinning installations by means of transfer lines or “conveyors”. Points are provided along these transfer lines for dividing the streams, so as to deliver the melt into the various spinning and/or granulating devices. Means for pumping the melt may also be installed along these transfer lines, such as for example gear pumps or extruders, in order to generate sufficient pressure, in order to overcome the pressure drop through the pipe work, and to obtain the desired polymer flow rate into each segment of the line.

In the case of spinning devices fed with polymers in granule form, usually the first component of the spinning device is an extruder, which has the function of melting, homogenizing and pressurizing the polymer melt and thus feeding a stream of polymer melt with a defined flow rate and at a defined temperature and pressure.

Advantageously, for spinning devices that use granules of moisture-sensitive raw materials, such as a polyester or polyamide, the polymer may undergo a drying operation upstream of the extruder.

In another embodiment, for certain moisture-sensitive raw materials such as a polyester or polyamide, the extruder may be equipped with one or more venting zones in order to reduce the moisture content of the melt.

Optionally, for certain raw materials and products for which the final application requires a high tenacity, such as high-tenacity nylon-6,6 polyamide yarn for the manufacture of tyres, the polymer may be subjected, upstream of the spinning device, to a post-condensation step in the solid (granulated polymer) phase or liquid (melt) phase in order to increase its molar mass.

Optionally, for certain raw materials and products for which the final application requires a high tenacity, such as high-tenacity nylon-6,6 polyamide yarn for the manufacture of tyres, the extruder may be equipped with one or more venting zones in order to increase and/or control the molar mass.

Optionally, for spinning devices connected to the polymerization process, the raw material is fed directly into the spinning device via the “conveyor” in the melt state and not in the form of granules, the presence of an extruder not being necessary.

Optionally, for products containing one or more additives, the extruder may be equipped with a metering system for introducing said additive or additives into the main polymer. This metering may be carried out directly with one or more pure additives or with additive concentrates, usually called master batches.

A master batch is a composition having a high additive concentration and a “vehicle” compatible with the main polymer of the product. The “vehicle” may be a polymer or a liquid.

The type of metering equipment depends on the form in which the additive or the master batch is metered.

In the case of solid additives, a metering device of the feed screw type is usually employed and the point of introduction may be the main inlet of the extruder jointly with the feed of the main polymer granules, or in an unpressurized additive injection zone located along the extruder.

For additives in master batch form, the vehicle of which is a polymer, the metering device may be a system comprising an additional extruder that pre-melts the master batch, pressurizes it and meters it by means of a metering pump, the amount of master batch metered being fed at a point, along the main extruder, advantageously without pressure.

For additives in the form of a master batch in which the vehicle is a liquid, the metering device may be a system comprising one or more metering pumps, which introduce the liquid master batch at the main inlet of the extruder jointly with the feed with the main polymer granules, without any pressure, or at a point under pressure located along the extruder.

Optionally, for products containing additives, the additives may also be added to the main polymer during the polymerization phase. In such cases, equipment for metering them into the spinning device is not necessarily used.

For economic reasons, so as to reduce the investment and production costs, a spinning device comprises an extruder for feeding several spinning positions so as to produce several yarns simultaneously, typically between 6 and 200 yarns. Consequently, the total throughput of the extruder is typically several times greater than the individual flow rate required for obtaining one yarn. As a result, the spinning devices include a manifold for delivering a polymer stream to various spinning positions, usually called spinning heads.

This manifold consists of heated tubes that divide and feed the polymer stream between the various spinning heads.

Optionally, means for pumping the melt may be installed at any point on the manifold, upstream of the point or points where the polymer stream is divided, such as for example a gear pump or an extrusion screw in order to generate sufficient pressure to overcome the loss of pressure caused by the pipework of the manifold and to control the desired flow rate of polymer fed into each segment of the line or spinning head.

The spinning heads generally comprise dosing pumps and screen-pack/spinneret assemblies. They also include means for maintaining the temperature of the dosing pumps and the screen-pack/spinneret assemblies, and also means for transporting the polymer melt from the outlets of the manifold to the inlet of the dosing pumps. In a manner similar to the manifold, these transport means of the spinning devices formed by pipework for transporting the polymer melt in order to feed the polymer into the spinning heads may divide the melt stream if more than one dosing pump is to be fed.

Before passing through the screen-pack/spinneret assembly, the polymer melt must be metered with the necessary precision in order to determine the correct linear density of each yarn produced. The dosing pump carries out this metering. Depending on the metering function, the dosing pump generates sufficient pressure to overcome the pressure drop through the screen-pack/spinneret assembly, typically between 50 and 500 bar. The dosing pumps may have one inlet and several outlets if more than one screen-pack/spinneret assembly is to be fed.

The screen-pack/spinneret assemblies comprise filtering elements and spinnerets. The filtering elements and the spinnerets are parts that have to be replaced very often, with a frequency of between 1 and 100 days, usually between 10 and 50 days. For this reason, the screen-pack/spinneret is an assembly comprising these two elements, enabling them to be rapidly and simply replaced without interrupting the feed of the spinning head, making the operation of the spinning device industrially viable. Each screen-pack/spinneret typically produces from 1 to 4 yarns, and preferably one yarn. The screen pack comprises one or more filtering elements and a spinneret, which is a disc provided with capillaries via which the melt is extruded, thus forming the filaments. The pressure drop in the screen pack corresponds to the sum of the pressure drops caused by the filtering elements and the capillaries of the spinneret.

The filtering elements of the screen pack make it possible to retain the contaminating elements present in the polymer melt.

Operationally, the maximum lifetime of a screen-pack/spinneret assembly corresponds to the operating time of the screen pack before it is necessary to replace it, i.e. when the pressure drop caused by the screen pack is too high. This maximum life is defined as a function of the initial or start-up pressure, of the average rate of pressure rise of the screen pack, and of the permitted maximum pressure for the screen pack. The permitted maximum pressure depends on the constructional characteristics of the screen pack and possibly also on limitations of the process, since the pressure results in additional heating of the melt. The formula below expresses this relationship:

Lₘₐₓ =(Pₘₐₓ−Pᵢ)/PR ₐᵥ,

in which:

Lₘₐₓ =maximum screen pack life;

Pₘₐₓ =maximum permitted screen pack pressure;

Pᵢ =initial or start-up pressure;

PRₐᵥ =average rate of pressure rise of the screen pack.

After being extruded through the capillaries, the preformed filaments still in the melt state pass through cooling means, where they solidify to form the continuous filaments of the yarn. The cooling means generally consist of an air blower, blowing air at a controlled temperature and rate.

After they have solidified, the filaments are gathered or made to converge into a bundle, which is the actual yarn. Before or after the filaments have been grouped together, a size is deposited on their surface. The size is an oil/water emulsion, typically having an oil concentration between 5% and 100% by weight, the purpose of which is to provide the yarn with cohesion between the filaments, to remove static electricity and to lubricate the yarn, so as to limit its abrasion or the abrasion of components in the subsequent yarn treatment devices or processes.

After the size has been applied, the yarn is introduced into an intermingling nozzle, this having the function of providing the yarns with greater cohesion, by the formation of filament entanglements and the formation of intermingling points or knots. This cohesion of the yarn is important for improving the performance of the subsequent yarn treatment processes, such as drawing and texturing, in the applications that require them.

After intermingling, the yarn is wound up to form reels, which is generally the final presentation of the yarn, by means of winders.

Optionally for the production of yarns of the FDY type, before the yarns are wound up by the winder, they pass over a set of rolls driven at defined speeds and at defined temperatures so as to obtain the mechanical and thermal properties necessary for the direct use of the applications in which they are required. The number, distribution and speed/temperature conditions of these rolls may vary considerably depending on the raw material used and on the desired final properties. Typically, FDY machines possess 2 to 5 sets of rolls.

Optionally, to produce yarns of the FDY type, before wind-up, more than one intermingling nozzle may be used to obtain cohesion suitable for direct use of the applications in which they are required.

The relationship between the linear density of the yarn produced and the process parameters, defined by the following equation, gives the mass balance of the installation:

linear density =spinning machine throughput/number of yarns of the machine/winding rate.

The operation of the spinning process is particularly sensitive to the presence of contaminants in the polymer melt. The presence of these contaminants may cause the filaments to rupture during the extrusion phase through the capillaries, the cooling phase or the drawing phase in the case of the FDY process, and therefore directly compromise the efficiency of the process and the uniformity of the yarns. These ruptures may cause complete rupture of the yarn, called a spinning breakage.

In the production of yarns having a low filament linear density, typically between 0.5 and 1.5 dpf, usually called microfibers, or in the production of FDY yarns the criticality or sensitivity of the process to contaminants is even more acute.

In the prior art, for the purpose of reducing yarn breakages (spinning breakages), and therefore of improving the efficiency of the spinning process, the contaminants are removed from the melt by the filtering elements of the screen pack. Typically, these elements are metal powders with a particle size between 50 and 1000 microns for filtering coarser contaminants and filter cloths with a nominal aperture of between 10 and 100 microns for filtering finer contaminants. The contaminants are impurities present in the melt and may derive from the processes for producing the raw material (polymer).

The filter cloths may be of conventional (woven) type or of the non-woven type. Conventional woven cloths are made up of woven metal wires, the nominal opening of which is defined by the diameter of the metal wires and the type of construction of the fabric. Cloths of the non-woven type are also made up of metal wires, however these forming a non-woven mat. Non-woven cloths have advantages over conventional cloths, since they possess the characteristic of partially retaining finer particles than their nominal opening, whereas conventional cloths retain practically no particles smaller than their nominal opening. Another advantage of non-woven cloths lies in their effect of fragmenting non-solid contaminants, such as gels (degraded polymers with a gelatinous consistency) by shear. Such contaminants are not readily retained by filter cloths as such contaminants are deformable and non-rigid, but in the case of non-woven filter cloths their fragmentation into smaller particles significantly lessens the deleterious impact of these contaminants.

Owing to these advantages, non-woven filter cloths must preferably be used in the screen packs. If the raw material is nylon-6,6 polyamide, which has a higher tendency to undergo thermal degradation with the formation of gels, the use of non-woven cloths is even more recommended.

In the case of products containing additives, the additive particles or agglomerates having a size greater than the acceptable limit for the spinning process—this limit being typically between 1 and 10 microns depending on the product—also behave as contaminants in the spinning process, i.e. they may cause spinning breakages and also contribute to reducing the maximum lifetime of the screen pack, especially by clogging the filters.

Thus, the efficiency of the process depends greatly on the effectiveness of the melt filtration. In the prior art, filtration allows particles with a size of between 10 and 50 microns, preferably between 15 and 30 microns, to be removed.

The use of filtering elements effective for filtering finer particles improves the performance of the process by reducing the number of spinning breakages, but has the drawback of greatly reducing the lifetime of the filtering element, and therefore of the constituent screen pack containing the filtering element. In the prior art, the time before having to replace the screen pack (maximum life) is typically between 1 and 100 days.

Consequently, the maximum degree of filtration industrially viable for a spinning process and for a specific product, usually measured by the opening of the finest filtering element of the screen pack, is determined by the compromise between the process performance, or number of spinning breakages, usually measured as the number of breakages per tonne of yarn produced, and the maximum lifetime of the screen packs, usually measured in days.

In the current state of the art, the compromise between degree of filtration, spinning breakage index and maximum screen-pack life for a process for spinning synthetic continuous filament yarn lies between the values given below:

degree of filtration→10 to 100 microns;

necessary replacement of the screen pack→1 to 100 days

spinning breakage index→0.5 to 20 breakages/tonne.

The objective of the present invention is to improve the compromise between filtration efficiency, spinning breakage index and necessary replacement or lifetime of the screen pack for a process for spinning synthetic continuous filament yarn. Thus, the process of the invention allows the efficiency in filtering the polymer melt to be increased, which has the effect of reducing the breakage per tonne index of spun polymer, without reducing the maximum lifetime of the screen packs, compared with an identical process not employing the invention. The process of the invention also makes it possible, according to another embodiment, to increase the lifetime of the screen packs, without increasing the breakage per tonne index and without modifying the filtration efficiency of the filtering elements contained in the screen packs, or a combined effect on the lifetime of the screen packs and the breakage per tonne index.

The present invention consists of a spinning process for the production of synthetic continuous filament yarns that can be employed in the continuous filament production industry.

Suitable polymers are those which can be hot-spun, such as, among others, polyesters, polyamides and polyolefins.

The spinning process according to the invention comprises two filtration steps: a first filtration corresponding to prefiltration, employing one or more centralized filters located in the polymer melt transfer lines, and a second, final, filtration obtained by the filtering elements contained in the screen packs.

The present invention consists of a novel configuration of the process for spinning synthetic continuous filament yarns, which comprises two filtration steps:
a first filtration of the polymer melt, corresponding to a prefiltration carried out in a centralized filter placed in the polymer melt transfer lines; and
a final filtration carried out in the filtering elements of the screen packs.

In a preferred embodiment of the invention, the filtering elements of the screen packs are made up of non-woven filter cloths.

According to the invention, a second filter suitable for filtering the polymer melt is placed in the polymer transfer lines, this filter being called hereafter the “centralized filter”.

The polymer melt transfer lines may be segments of lines of the “conveyor” between the polymerization equipment and the spinning devices, or segments of the manifold of the spinning device.

The centralized filter may be located at any point on a melt transfer line. However, when pumping means are present on the transfer line or segment, the filter is preferably placed downstream of these pumping means.

By using a centralized filter in accordance with the process of the invention it is possible to filter some of the contaminants in the prefiltration step and to improve the filtration in the filtering elements of the screen packs.

Thus, it is possible to improve the compromise between the final degree of filtration, spinning breakage index and maximum life of the screen pack, according to one of the following forms:
improvement in the final degree of filtration and consequent reduction in the breakage per tonne index, without reducing the maximum life of the screen packs, relative to a reference process without prefiltration;
increase in the maximum life of the screen packs, without reducing the degree of filtration, and therefore without increasing the breakage per tonne index, relative to a reference process without prefiltration;
any intermediate condition between the two alternatives mentioned above.

If the filter is placed in the manifold of the spinning device, downstream of pumping means and upstream of the dosing pumps, without any other pumping means between the filter and the dosing pumps, the design of the filter must allow the feed pressure in the dosing pumps to be greater than about 5 bar and preferably greater than about 30 bar.

If the filter is placed upstream of polymer melt pumping means, the design must allow the feed pressure of the polymer in the pumping means to be greater than about 5 bar and preferably greater than about 20 bar.

The filter used may be of the conventional or discontinuous type, or a filter allowing continuous operation.

In conventional filters, the filtration is carried out in filtration modules which have a life cycle. At the end of the life cycle of a filtration module, when the filtering elements are saturated with contaminants, an operation to replace the module must be carried out.

In continuously operating filters, the filtering elements are being continually renewed, and therefore do not require to be periodically replaced when saturated with contaminants. Patent US005090887A relates to one type of continuously operating filter.

Preferably, continuously operating filters are used as first filter in the process according to the invention, since they allow the variations in the process parameters, such as pressure, temperature and lifetime, to be better controlled and minimize the amplitude of these variations. Thus, since the process parameters are more stable, the characteristics of the yarns produced are more uniform.

According to one of the embodiments of the invention, additives may be added to the polymer melt, especially in the form of a master batch addition. In this case, the centralized filter is advantageously placed in a line or segment placed downstream relative to the point of master batch addition.

The polymers comprising the melt may be chosen from the following group, without however being limited to them: polyesters, polyamides, polyolefins, blends thereof and copolymers thereof. For example, we may mention: nylon-6 polyamide, nylon-6,6 polyamide, polybutylene terephthalate (PBT), polyethylene terephthalate (PET) and polypropylene. Preferably, nylon-6,6 polyamide is employed, or else copolymers, blends or alloys thereof.

The yarns or filaments obtained at the end of the process may be of the LOY, POY or FDY type or chopped fibres obtained therefrom, having a linear density varying between about 10 and 3000 dtex. The yarns may comprise 1 to 500 filaments.

Examples are described below for the purpose of better explaining and illustrating the invention. These examples are given merely by illustration and are in no way limiting in character.

### EXAMPLE 1.1

### Configuration of reference process 1 without prefiltration (comparative example):

feed of the spinning device with polymer granules;

twin-screw extruder with venting, with a polymer throughput of 180 kg/h and a vacuum pressure of 750 mbar absolute;

pumping equipment of the gear pump type for a 180 kg/h throughput and output pressure of 150 bar, placed downstream of the extruder and upstream of the first flow division in the manifold, such as a melt pumping means;

the spinning device comprises:
a manifold with 1×3×2 flow divisions, i.e. 6 polymer output lines;
three spinning heads fed via two inlets, each spinning head comprising four dosing pumps, with 12 screen-pack/spinneret assemblies, a 1×2 flow division between each inlet of the spinning head and inlet of the dosing pumps;
the dosing pumps comprise 1 inlet and 3 outlets;
the screen-pack/spinneret assemblies comprise 15-micron non-woven filter cloths, and spinnerets for the production of two 68-filament yarns, the diameter of the spinneret being 80 mm;

blown-air equipment of the transverse type;

size application means;

yarn guides;

intermingling equipment;

winders for winding 6 bobbins at 4200 m/min.

Raw material used: nylon-6,6 polyamide containing titanium dioxide as opacifying agent and friction reducer.

Product manufactured: 68-filament 101-dtex nylon-6,6 POY continuous filament yarn, containing titanium dioxide as an opacifying agent and a friction reducer.

Operating characteristics of the process obtained:

spinning breakages: 3.1 breakages/tonne

average rate of pressure rise in the screen packs: 3.5 bar/day

initial start-up pressure of the screen pack: 250 bar

permitted maximum pressure in the screen pack: 350 bar

maximum life of the screen pack: (350−250)/3.5 =28 days

minimum pressure observed upstream of the dosing pump: 70 bar

EXAMPLE 1.2

### Configuration of a process in accordance with Example 1.1, but with prefiltration according to the invention:

This example is identical to Example 1.1 but with the presence of a centralized filter operating continuously with a throughput of 180 kg/h. The filter is a filter of the type of those described in patent US005090887A. The filter is placed on a segment of the manifold downstream of the pumping equipment (gear pump type) and upstream of the first flow division of the manifold. The filter is equipped with 8-micron filter cloths.

Raw material used: nylon-6,6 polyamide, containing titanium dioxide as opacifying agent and friction reducer, with the same concentration as that of Example 1.1.

Product manufactured: 68-filament 101-dtex nylon-6,6 POY continuous filament yarn, containing titanium dioxide as an opacifying agent and a friction reducer.

Operating characteristics of the process:

spinning breakages: 2.4 breakages/tonne

average rate of pressure rise: 1.6 bar/day

initial start-up pressure of the screen pack: 250 bar

permitted maximum pressure in the screen pack: 350 bar

maximum life of the screen pack: (350−250)/1.6 =62 days

minimum pressure observed upstream of the dosing pumps: 30 bar

### EXAMPLE 2.1

### Configuration of a reference process 2 without prefiltration (comparative trial):

feed of the spinning machine with polymer granules;

twin-screw extruder with venting, with a polymer throughput of 180 kg/h and a vacuum pressure of 750 mbar absolute;

master batch granule metering device of the feedscrew type, with feed into the inlet of the extruder;

pumping equipment of the gear pump type for a 180 kg/h polymer throughput and output pressure of 160 bar, placed downstream of the extruder and upstream of the first flow division in the manifold, such as a melt pumping means;

the spinning device comprises:
a manifold with 1×3×2 flow divisions, i.e. 6 polymer output lines;
three spinning heads fed via two inlets, each spinning head comprising four dosing pumps, with 12 screen-pack/spinneret assemblies, a 1×2 flow division between each inlet of the spinning head and inlet of the dosing pumps;
the dosing pumps comprise 1 inlet and 3 outlets;
the screen-pack/spinneret assemblies comprise 15-micron non-woven filter cloths, and spinnerets for the production of two 68-filament yarns, the diameter of the spinneret being 80 mm;

blown-air equipment of the transverse type;

size application means;

yarn guides;

intermingling equipment;

winders for winding 6 bobbins at 4200 m/min.

Raw material used: nylon-6,6 polyamide containing titanium dioxide as opacifying agent and friction reducer.

Master batch used: master batch based on nylon-6,6 containing 40 wt% zinc sulphide as opacifying and antimicrobial agent, with a dose of 5 wt% master batch in the main polymer (9 kg/h).

Product manufactured: 68-filament 101-dtex nylon-6,6 POY continuous filament yarn containing titanium dioxide as opacifying agent and friction reducer and zinc sulphide as opacifying and antimicrobial agent.

Operating characteristics of the process:

average rate of pressure rise: 170 bar/day

initial start-up pressure of the screen pack: 250 bar

permitted maximum pressure in the screen pack: 350 bar

maximum lifetime of the screen pack: (350−250)/170 =0.6 days

minimum pressure observed upstream of the dosing pumps =80 bar

### EXAMPLE 2.2

### Configuration of a spinning process with prefiltration according to the invention:

This example is identical to Example 2.1 but with the presence of a centralized filter operating continuously with a throughput of 180 kg/h. The filter installed corresponds to the type of filter described in patent US005090887A. The filter is placed on a segment of the manifold downstream of the pumping equipment (gear pump type) and upstream of the first flow division of the manifold. The filter is equipped with 8-micron filter cloths.

Raw material used: nylon-6,6 polyamide containing titanium dioxide as opacifying agent and friction reducer.

Master batch used: master batch based on nylon-6,6 containing 40% zinc sulphide as opacifying and antimicrobial agent, with a dose of 5% master batch in the main polymer (9 kg/h).

Product manufactured: 68-filament 101-dtex nylon-6,6 POY continuous filament yarn containing titanium dioxide as opacifying agent and friction reducer and zinc sulphide as opacifying and antimicrobial agent.

Operating characteristics of the process:

average rate of pressure rise: 40 bar/day

initial start-up pressure of the screen pack: 250 bar

permitted maximum pressure in the screen pack: 350 bar

maximum lifetime of the screen pack: (350−250)/40 =2.5 days

minimum pressure observed upstream of the dosing pumps =30 bar

1.-16. (canceled)

17. A spinning process for the production of synthetic polymer continuous filament yarns and providing a compromise between filtration efficiency, spinning breakage index and lifetime of screen pack, comprising a feed of a polymer melt into at least one spinning device via one or more transfer lines, each spinning device comprising at least one screen-pack/spinneret assembly in which filtering elements are present in the screen packs, also comprising a prefiltration of the polymer melt in a second filtration means (centralized filter) located in a transfer line, and a final filtration being carried out by filtering elements in the at least one screen pack.

18. The spinning process for the production of synthetic polymer continuous filament yarns as defined by claim 17, wherein the one or more polymer melt transfer lines comprise polymer melt transfer line segments emanating from a polymerization installation to a spinning device.

19. The spinning process for the production of synthetic polymer continuous filament yarns as defined by claim 17, wherein the one or more transfer lines comprise segments of lines of polymer melt distribution means (manifold) of a spinning device.

20. The spinning process for the production of synthetic polymer continuous filament yarns as defined by claim 19, said distribution means or manifold of the spinning device comprising polymer melt pumping means and the spinning device comprising dosing pumps for feeding the polymer melt into the one or more screen-pack/spinneret assemblies, the second, centralized filter being placed in a segment of the manifold downstream of the pumping means and upstream of the dosing pumps, the design of the centralized filter allowing a melt feed pressure in the dosing pumps to be maintained at above 5 bar.

21. The spinning process for the production of synthetic polymer continuous filament yarns as defined by claim 20, wherein the design of the centralized filter allows a melt feed pressure in the dosing pumps to be maintained at above 30 bar.

22. The spinning process for the production of synthetic polymer continuous filament yarns as defined by claim 17, wherein the spinning device comprises polymer melt pumping means and the centralized filter being placed upstream of such pumping means, the design of the filter allowing a feed pressure in these pumping means to be maintained at above 5 bar, optionally above 20 bar.

23. The spinning process for the production of synthetic polymer continuous filament yarns as defined by claim 17, wherein the filtering elements of the screen packs comprise non-woven filter cloths.

24. The spinning process for the production of synthetic polymer continuous filament yarns as defined by claim 17, wherein the second filter, or centralized filter, comprising a continuously operating filter.

25. The spinning process for the production of synthetic polymer continuous filament yarns as defined by claim 17, wherein the second filter, or centralized filter, comprising a discontinuously operating filter.

26. The spinning process for the production of synthetic polymer continuous filament yarns as defined by claim 17, comprising an addition into the polymer melt of additives in the form of a master batch of such additives by metering means placed on a transfer line, the second filtering means or centralized filter being placed in a transfer line downstream of the metering means.

27. The spinning process for the production of synthetic polymer continuous filament yarns as defined by claim 17, wherein the polymer is selected from the group consisting of polyesters, polyamides, polyolefins, blends or alloys and copolymers thereof.

28. The spinning process for the production of synthetic polymer continuous filament yarns as defined by claim 27, wherein the polymer is selected from the group consisting of nylon-6 polyamide, nylon-6,6 polyamide, polybutylene terephthalate (PBT), polyethylene terephthalate (PET) and polypropylene.

29. The spinning process for the production of synthetic polymer continuous filament yarns as defined by claim 28, wherein the polymer is nylon-6,6 or copolymers or blends based on nylon-6,6.

30. The spinning process for the production of synthetic polymer continuous filament yarns as defined by claim 17, wherein the yarns or filaments are LOY yarns, POY yarns, FDY yarns or chopped fibers obtained therefrom.

31. The spinning process for the production of synthetic polymer continuous filament yarns as defined by claim 17, said yarns having a linear density ranging from 10 to 3,000 dtex.

32. The spinning process for the production of synthetic polymer continuous filament yarns as defined by claim 17, said yarns comprising 1 to 500 filaments.

33. A synthetic polymer continuous filament yarn produced via the spinning process as defined by claim 17.
